(19) United States
(12) Patent Application Publication
(10) Pub. No.: US 2014/0016797 A1
(43) Pub. Date: Jan. 16, 2014

(54) Method for Changing Audio System Mode for Roof Open/Closed Condition

(71) Applicants: Chait Phagoo, Westland, MI (US); John Richard Blankenship, Dearborn, MI (US); Zhang Yan, Northville, MI (US); Payam Naghshtabrizi, Farmington Hills, MI (US); Viet Quoc To, West Bloomfield, MI (US)

(72) Inventors: Chait Phagoo, Westland, MI (US); John Richard Blankenship, Dearborn, MI (US); Zhang Yan, Northville, MI (US); Payam Naghshtabrizi, Farmington Hills, MI (US); Viet Quoc To, West Bloomfield, MI (US)

(73) Assignee: FORD GLOBAL TECHNOLOGIES, LLC, Dearborn, MI (US)

(21) Appl. No.: 13/549,661

(22) Filed: Jul. 16, 2012

(51) Int. Cl. H02B 1/00; H04B 1/00

(52) U.S. Cl. 381/86

(57) ABSTRACT

A method and system for changing a digital signal processing (DSP) mode of an audio system in a motor vehicle having a roof movable between open and closed positions. The open/closed position of the roof is determined and the audio system is operated in a first DSP mode when the roof is in the closed position and operated in a second DSP mode when the roof in the open position. The first and second DSP modes have different processing characteristics adapted for the acoustics of the passenger cabin when the roof is closed or open. The open/closed roof position may be determined by a roof position sensor or by the actuation of a roof position switch operated by a vehicle occupant.

### TECHNICAL FIELD

The present invention relates to audio systems for motor vehicles, and more specifically to an audio system for a vehicle having a roof moveable between an open position and a closed position.

### BACKGROUND

Many current motor vehicles have an audio system including a digital signal processing (DSP) chip or unit for controlling various qualities of sound output by speakers in the passenger compartment. Among the sound characteristics that may be controlled by a DSP chip or unit are equalization, delay, reverberation, echo, and early or late reflection. Normally, a particular DSP mode may be selected and/or customized by a vehicle occupant.

In vehicles with roofs that are movable between open and closed positions, such as sun roofs or convertible roofs, it may be advantageous to change the DSP mode when the roof changes between the closed and open condition to achieve better quality acoustics for the existing roof condition. This is particularly true for a convertible vehicle in which the entire vehicle roof and rear window are retracted or stowed, since this results the complete elimination of the surfaces that would otherwise reflect sound waves back toward the vehicle interior.

When a moveable/retractable roof transitions between the closed and opened conditions, the DSP mode should therefore be changed to one that is more optimum for the new listening conditions. If such a DSP mode change requires a separate, intentional action by a vehicle occupant when the roof changes condition, the occupant may forget to take that action and so the audio system will remains in a non-optimal DSP operational mode, and hence will not provide the best sound for the current listening environment.

### SUMMARY

In an embodiment disclosed herein, a method of changing a digital signal processing (DSP) mode of an audio system in a motor vehicle comprises determining whether a movable roof is in an open position or a closed position, operating the audio system in a first DSP mode when the roof is determined to be in the closed position, and operating the audio system in a second DSP mode when the roof is determined to be in the open position. The first and second DSP modes have different processing characteristics adapted for the acoustics of the passenger cabin when the roof is closed or open.

The open/closed roof position may be determined by a roof position sensor or by the actuation of a roof position switch operated by a vehicle occupant.

In another embodiment, an audio system for a motor vehicle comprises an input port receiving signals from at least one of a roof open/close switch and a roof position sensor, and a digital processor. The digital processor operates in a first DSP mode when the signals indicate the roof is in the closed position and changes to a second DSP mode stored in audio system memory when the signals indicated the roof is in the open position.

In another embodiment, a method of operating an audio system in a motor vehicle having a roof movable between an open position and a closed position comprises operating in a roof-closed DSP mode when the roof is in the closed position, in response to a first occupant instruction to move the roof to the open position, storing processing characteristics of the roof-closed DSP mode and changing to a roof-open DSP mode stored in audio system memory, and in response to a second occupant instruction to move the roof to the closed position, returning to the stored roof-closed DSP mode.

### BRIEF DESCRIPTION OF THE DRAWINGS

Embodiments of the present invention described herein are recited with particularity in the appended claims. However, other features will become more apparent, and the embodiments may be best understood by referring to the following detailed description in conjunction with the accompanying drawings, in which:

FIG. 1 is a schematic block diagram of a vehicle audio system and related moveable roof components;

FIG. 2 is a flow chart showing a method by which automatic DSP mode selection may be achieved; and

FIG. 3 is a flow chart showing a second method by which automatic DSP mode selection may be achieved.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

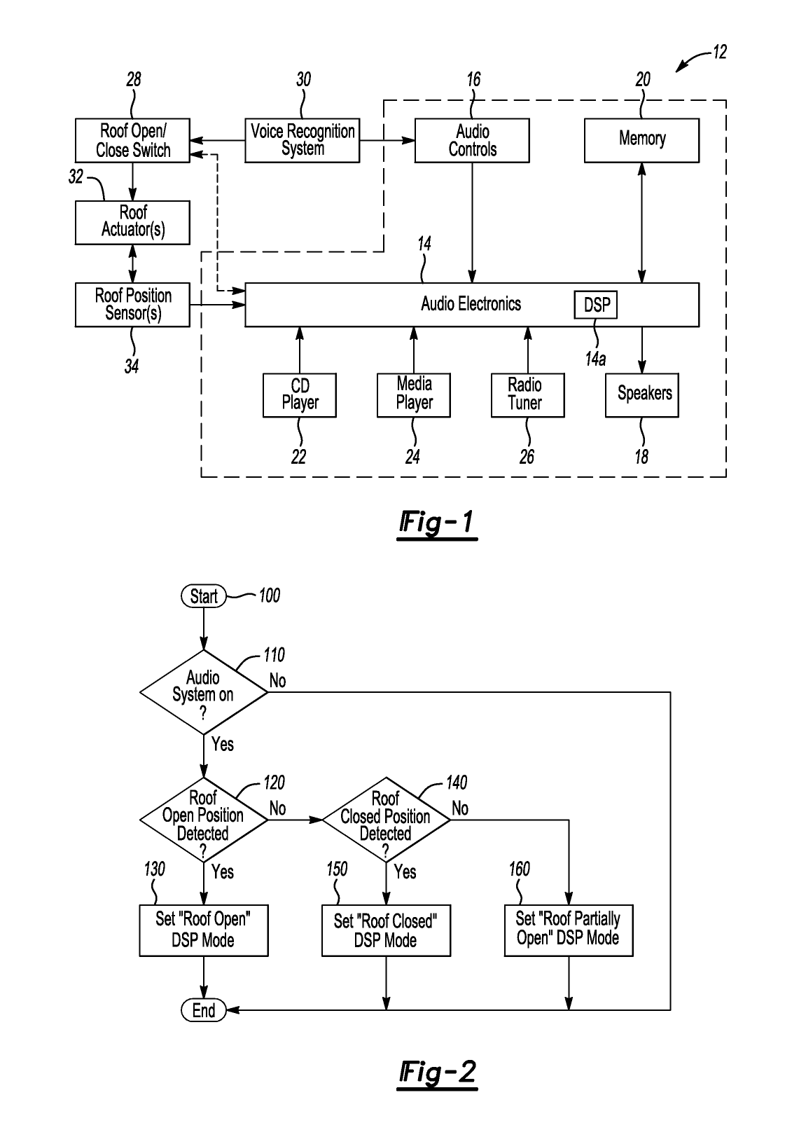

As depicted schematically in FIG. 1, a vehicle audio system (generally indicated at 12) includes audio electronics 14, audio controls 16 that are actuated by a vehicle occupants to select operating modes/characteristics of the audio system, speakers 18 located within a vehicle passenger cabin or other interior space, memory 20, and input devices such as, for example, a CD player 22, a radio tuner 24, and a digital media player 26.

Audio electronics 14 includes a digital signal processor (DSP) 14a. As is well known in the vehicle audio system art, DSP 14a may be a special-purpose chip contained in the audio system electronics, or may be implemented by software run by a multi-function processor/chip.

DSP 14a may provide customizable sound characteristics such as equalization, reverberation, echo, and early or late reflection, bass enhancement, multiband dynamics, delay compensation, speaker compensation, and stereo image widening. A particular DSP mode may be selected and/or customized by a vehicle occupant.

A roof open/close switch 28 and/or a voice recognition system 30 are operatively related to audio system 12. Roof open/close switch 28 may be actuated manually by a vehicle occupant to activate one or more roof actuators 32 in order to control the open/closed condition of a movable vehicle roof (not shown). A voice recognition system 30 may provide for “hands-free” activation of roof actuators 32. Voice recognition system 30 may also be used make control inputs to audio system 12, as is well known in the art.

One or more roof position sensors 34 are operatively associated with the roof and/or the roof actuators 32. For example, roof position sensor 34 may comprise a first limit switch that detects when the roof is in the full open position and a second limit switch that detects when the roof is in the full closed position. Alternatively, roof position sensor 34 may detect the position of one or more portions of the roof actuator system 32. Roof position sensor 34 is operatively connected with an input port of audio electronics 14 in order to send signals indicating the roof position. Roof position sensor 34 may provide a binary OPEN or CLOSED status, or may also provide signals indicating one or more intermediate positions of the roof

Referring now to FIG. 2, a schematic flow chart of a method for automatically changing the DSP mode settings of an audio system based upon the open/closed condition of the vehicle roof is described. The method may be implemented by logic contained in software resident in the audio system electronics. Beginning at block 100, the method progresses to block 110 where a check is made to see whether the audio system is turned on. If “YES,” at block 120 a check is made to determine whether the roof is in the open position. This may be determined from a roof position sensor (such as that indicated by 34 in FIG. 1) for example.

When the ROOF OPEN position is detected (block 120, “YES”), the method progresses to block 130 where the ROOF OPEN DSP mode is implemented. The ROOF OPEN DSP mode is optimized for the listening conditions existing when the movable roof is in the open, stowed, or down condition. If the check at block 120 results in “NO,” the method progresses to block 140 where a check is made of whether the roof in in the closed position. If “YES,” at block 150 the ROOF CLOSED DSP mode is implemented by the audio system.

The ROOF OPEN and ROOF CLOSED DSP modes have previously been stored/saved in system memory and may consist of setting that were pre-set (as the audio system comes from its manufacturer) by audio systems designers in the manner expected to be most appropriate for enjoying audio content when the roof is in open and closed conditions respectively. The DSP mode settings may be selected by a vehicle occupant from a menu of pre-set options. For example, some audio systems have pre-set DSP modes developed by audio system designers to provide enjoyable listening for different types of audio content. Such pre-set modes are often given names such as “ambient,” “jazz,” and “stadium.” It may also be possible for a vehicle occupant to create (using the audio system controls) a “customized” DSP mode according to their own preferences.

If the check at block 140 results in “NO,” the method progresses to block 160 and a ROOF PARTIALLY OPEN DSP mode is implemented by the audio system. There may be only a one ROOF PARTIALLY OPEN DSP mode that is implemented at all positions of the roof between full open and full closed. If the system is able to sense multiple roof positions between full open and full closed, there may be multiple, distinct DSP settings optimized for various roof positions between full open and full closed.

As an alternative to the ROOF PARTIALLY OPEN DSP mode, if the checks at blocks 120 and/or 140 indicate that the roof is in any position other than fully closed, the audio system may operate in ROOF OPEN DSP mode.

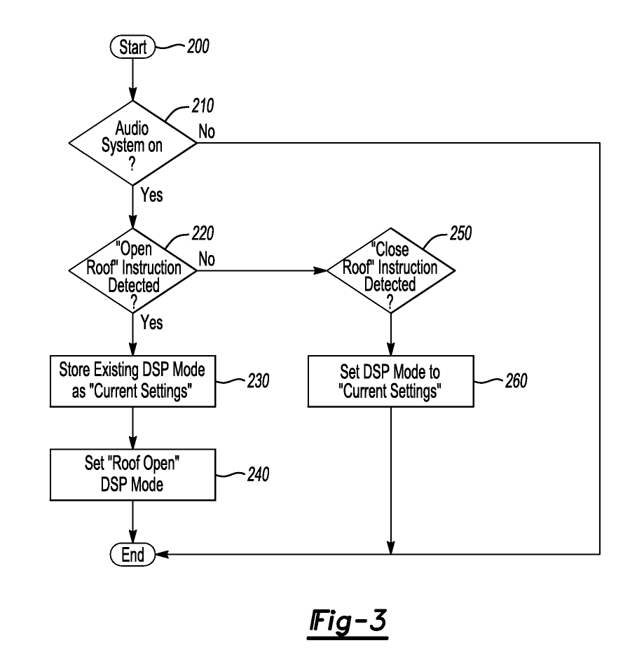

FIG. 3 is a schematic flow chart of another method for automatically changing the DSP mode settings. In this method, the open/closed condition of the roof is determined by monitoring instructions by a vehicle occupant to open and/or close the roof, thus eliminating the requirement for a roof position sensor. Open/close instructions may be generated by manual actuation of a roof open/closed switch and/or by a voice recognition system. For example, in FIG. 1 switch 28 and voice recognition system 30 are shown connected directly to an input port of audio electronics 14.

The method may be implemented by logic contained in software resident in the audio system electronics. Beginning at block 200, the method progresses to block 210 where a check is made to see whether the audio system is turned on. If “YES,” at block 220 a check is made to determine whether an “open roof” instruction is detected. Such an instruction may be received from a manual roof position switch or via a voice recognition system (such as 28 and 30 in FIG. 1).

When an “open roof” instruction is detected (block 220, “YES”), the method progresses to block 230 where the DSP mode settings currently in use or active are saved to memory and flagged as “CURRENT SETTINGS.” Progressing to block 240, the DSP settings are changed to a “ROOF-OPEN” mode that has previously been saved in the system memory.

Next, at block 240, the audio system DSP mode changes to a “roof-open” mode optimized for the listening conditions existing when the movable roof is in the open, stowed, or down condition. The steps of blocks 230 and 240 may occur essentially simultaneously or concurrently.

Returning to block 220, if no “open roof” instruction is detected (“NO”), the method progresses to block 250, where a check is made for a “close roof” instruction. If the instruction is detected, (“YES”), the method progresses to block 260 and the DSP mode returns to the settings stored/saved to system memory as “current DSP mode” when the roof was last in the closed condition.

If the “open roof” and/or “close roof” instructions are received from a manually operated switch (such as roof open/closed switch 28), it may be desirable to require that the switch be held in the open or closed position for a discrete time period, such as two seconds, in order to constitute a valid instruction. This will reduce the likelihood that an accidental or unintentional switch actuation causes the audio system to change modes.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of changing a digital signal processing (DSP) mode of an audio system in a motor vehicle having a movable roof comprising:
determining whether the roof is in an open position or a closed position;
operating the audio system in a first DSP mode when the roof is determined to be in the closed position; and
operating the audio system in a second DSP mode when the roof is determined to be in the open position, the second DSP mode having a processing characteristic different from the first DSP mode.

2. The method of claim 1 wherein the open or closed position of the roof is determined by actuation of a roof position switch.

3. The method of claim 2 wherein the actuation of the roof position switch must be maintained for a fixed time period in order to be construed as an instruction to actuate the roof to the open position.

4. The method of claim 2 wherein the actuation of the roof position switch is effected by a voice recognition system.

5. The method of claim 1 wherein the open or closed position of the roof is determined by a signal from a limit switch.

6. The method of claim 1 further comprising a vehicle occupant selecting processing characteristics of at least one of first DSP mode and the second DSP mode.

7. The method of claim 1 wherein the processing characteristic is one of a delay, a reverberation, an echo, an early reflection, and a late reflection.

8. An audio system for a motor vehicle comprising:
an input port receiving signals from at least one of a roof open/close switch and a roof position sensor; and
a digital processor operating in a first digital signal processing (DSP) mode when the signals indicate a movable roof of the vehicle is in a closed position and changing to a second DSP mode stored in audio system memory when the signals indicated the roof is in an open position.

9. The system of claim 8 wherein processing characteristics of the first DSP mode are saved in audio system memory concurrent with the change to the second DSP mode.

10. The system of claim 8 wherein the digital processor returns to the first DSP mode upon receipt of a roof-closed signal indicating that the roof open/close switch has been actuated to move the roof from the open position to the closed position.

11. The system of claim 8 wherein at least one of first DSP mode and the second DSP mode comprises processing characteristics selected by a vehicle occupant.

12. The system of claim 8 wherein the signals are generated by actuation by a vehicle occupant of a manually operated switch.

13. The system of claim 8 wherein the signals are generated by a voice command detected by a voice recognition system.

14. The system of claim 8 wherein the roof position sensor comprises a limit switch.

15. A method of operating an audio system in a motor vehicle having a roof movable between an open position and a closed position comprising:
operating in a roof-closed DSP mode when the roof is in the closed position;
in response to a first occupant instruction to move the roof to the open position, storing processing characteristics of the roof-closed DSP mode and changing to a roof-open DSP mode stored in audio system memory, the roof-open mode having a processing characteristic different from the roof-closed DSP mode; and
in response to a second occupant instruction to move the roof to the closed position, returning to the roof-closed DSP mode.

16. The method of claim 15 further comprising selection by a vehicle occupant of processing characteristics of the roof-open DSP mode stored.

17. The method of claim 15 wherein the first occupant instruction comprises actuation of a manually operated switch by a vehicle occupant.

18. The method of claim 15 wherein the first occupant instruction comprises a voice command detected by a voice recognition system.

19. The method of claim 15 further comprising a vehicle occupant selecting processing characteristics of the roof-open DSP mode and storing the roof-open DSP mode.
